(19) United States
(12) Patent Application Publication
(10) Pub. No.: US 2019/0318276 A1
(43) Pub. Date: Oct. 17, 2019

(54) Automated Booking System

(71) Applicant: Jungle Bee, Inc., Newark, DE (US)

(72) Inventor: Michael Rouveure, Saint Martin (FR)

(21) Appl. No.: 16/382,043

(22) Filed: Apr. 11, 2019

Related U.S. Application Data
(60) Provisional application No. 62/656,218, filed on Apr. 11, 2018.

(51) Int. Cl. G06Q 10/02; G06Q 20/10; G06Q 50/14

(52) U.S. Cl. CPC G06Q 10/02; G06Q 50/14; G06Q 20/10

(57) ABSTRACT

The present invention relates to automated system for real time booking geared towards local attractions. The system includes a server that maintains data structures corresponding to a booking list and an ordered standby list. The booking list and the standby list have entries identifying at least one participant or item. The server receives input identifying a booking entry in the booking list to be cancelled and in response to receiving the input identifying the booking entry to be cancelled, retrieves a top entry of the ordered standby list, replaces the booking entry to be cancelled in the booking list with the top entry, and removes the top entry from the standby list.

This application claims the benefit of U.S. Provisional Application No. 62/656,218 filed on Apr. 11, 2018, the contents of which are incorporated herein by reference.

### TECHNICAL FIELD

The present invention relates to booking systems generally and in particular to an improved automated real time booking system.

### BACKGROUND ART

Online self-service systems for booking or purchasing airline tickets, hotels rooms and car rentals are known. Networks and associated software that enable automated transactions to be carried out among airlines, hotels and car rental companies and travel agencies, often known as global distribution systems (GDS) are established in the travel industry. Travel agencies have traditionally relied on GDS for services, products and rates to provide travel-related services to the consumers, who in turn traditionally relied on these agencies. Some global distribution systems can link services, rates and bookings thereby consolidating products and services across airline reservations, hotel reservations, and car rentals.

For example, U.S. Pat. No. 9,536,010 discloses methods, systems, and computer program products for automatically issuing travel documents. Tasks relating to issuance of travel documents are generated by an originating application in response to booking a travel service. The tasks are received and stored in a first queue until a triggering event, such as the arrival of a time for issuance of a document. In response to the triggering event, a task in the first queue may be placed in a second queue for transmission to an issuing application. The documents to be issued may be determined based on records in a passenger name record (PNR) stored in a database. The PNR may be determined based on the task. The PNR may be updated with information indicating whether task processing was successful. In the event of an error, information indicating the cause of the error may be added to the PNR.

U.S. Pat. No. 8,209,200 entitled “System and method for synchronizing passenger name record data” discloses a system and method are provided for maintaining updated passenger travel records across multiple system platforms. A network server is adapted to receive input data from a passenger including an indication that the passenger desires to purchase tickets or make reservations for travel related services. A booking engine acts to purchase the ticket or book the reservation and request and receive a copy of a passenger name record created by a global distribution system. The booking engine then forwards a copy of the received passenger name record to the database. The database is adapted to form an association between the received copy of the passenger name record and the input data received from the passenger, and store the copy of the passenger name record. The database may further perform a comparison between the input data and the received passenger name record to identify discrepancies.

U.S. Pat. No. 8,768,860 entitled “Method and system for presenting rates for travel services” and assigned to Expedia, Inc. discloses a method and system are provided for presenting rates for travel services using dynamic pricing bands. The dynamic pricing bands represent approximate rates for travel services relative to available rates during or close to the proposed dates of travel, or at or near the proposed travel destination. Each dynamic pricing band is keyed to a particular color, intensity, pattern, sound, or other graphical and/or audio characteristic, thereby providing the consumer a sense of the seasonal, regional, day of week, or other variability of rates for travel services without having to compare actual numbers. The dynamic pricing bands are applied to an interactive presentation of rates for travel services to allow the consumer to explore possible rate variations for particular travel services in a manner that provides a birds-eye view, is intuitive and user-friendly.

Although GDS systems as described above have been known for a while, improvements, particularly aimed at local attractions at destinations, are desired. It is thus an object of the present invention to provide an improved real time booking system and method suited for local attractions.

### SUMMARY OF INVENTION

In accordance with one aspect of the present invention, there is provided an automated system for booking. The system includes a server having: a processor, memory interconnected with the processor, and a network interface in communication with the processor. The memory stores processor executable instructions that, when executed, cause the processor to maintain data structures corresponding to a booking list and an ordered standby list. The booking list and the standby list store entries identifying at least one participant. The instructions further cause the processor to receive input requesting a new booking entry from a user for at least one new participant; and to receive and process payment information comprising account detail and payment amount for an activity corresponding to the new booking entry. Upon receiving the new booking entry and processing said payment information, the instructions cause the processor to add the new booking entry into the booking list; receive input identifying a booking entry in the booking list to be cancelled. In response to receiving the input identifying the booking entry to be cancelled: the instructions cause the processor to retrieve a top entry of the ordered standby list and upon retrieving the top entry, replace the booking entry to be cancelled in the booking list with the top entry; and remove the top entry from the standby list.

In accordance with another aspect of the present invention there is provided an application messaging system including: a client device and a server. The client device includes: a client processor in communication with a display, a client network interface and a computer readable medium storing application code (app). The app causes the client processor to: receive a list of users in communication with a messaging service; receive input selecting one of the users in the list of users; in response to receiving the input selecting one of the users, establish a messaging session with the selected user through the messaging service; display a user interface control for entering a new order entry; upon receiving input on the user interface control, receive data for the new order request; and send the data for the new order request to the server, while in said messaging session. The server includes: a server processor; memory interconnected with the server processor; a server network interface in communication with the server processor; the memory storing processor executable instructions. The instructions, when executed, cause the server processor to: provide the messaging service; maintain data structures corresponding to an order list for storing order entries identifying at least one participant or item; receive input requesting a new order entry from a user for at least one new participant or item; receive and process payment information including account detail and payment amount for an activity corresponding to the new order entry; and upon receiving said new order entry and processing said payment information add the new order entry into the order list.

In accordance with another aspect of the present invention, there is provided a non-transitory computer-readable medium for a widget includes processor executable installation instructions. The instructions, when executed by a computing device having a processor, memory interconnected with the processor and a network interface in communication with the processor, cause the computing device to execute several steps. These steps include: retrieving a Uniform Resource Identifier (URI) associated with the web application; installing the web application on the computing device; and upon instantiating the web application, displaying the content of the URI. The web application is on a server includes: a server processor; memory interconnected with the server processor, a server network interface in communication with the server processor. The memory of the server stores processor executable instructions that, when executed, cause the server processor to: maintain data structures corresponding to a booking list for storing booking entries identifying at least one participant; receive input requesting a new booking entry from an end user for at least one new participant; receive and process payment information includes account detail and payment amount for an activity corresponding to the new booking entry; upon receiving said new booking entry and processing said payment information: add the new booking entry into the booking list; and automatically apportion the payment amount between a first account associated with an owner of the server, and at least a second account associated with one of an agent or a supplier for said activity.

In accordance with other aspects of the present invention, there is provided a browser accessible, web-enabled platform where tour suppliers variously known as “tour operators”, “tour suppliers”, “show companies”, “event companies”, “amusement parks”; and agents variously known as “online activity specialists” (OAS), “online travel agencies” (OTA), travel agents, travel agencies, “activity desks” which may be independent or part of hotels or cruise ships; can each see real time space availability for tours, excursions, activities, tickets to shows and amusement parks and book them for participants.

### BRIEF DESCRIPTION OF DRAWINGS

In the figures, which illustrate by way of example only, embodiments of the present invention,

FIG. 1 is a schematic block diagram of a booking system, exemplary of an embodiment of the present invention including a server interconnected to computing devices;

FIG. 2; is a simplified block diagram of hardware components of the computing devices used in FIG. 1;

FIG. 3 is a flowchart of the steps taken by the server of FIG. 1 to implement a criterion related to minimum quantity of participants for tours, in one exemplary embodiment;

FIG. 4 is a flowchart of steps taken by the server of FIG. 1 to implement a two-step short-notice reservation procedure, in one exemplary embodiment;

FIG. 5 is a flowchart of the steps taken by the server FIG. 1, when an a tour supplier configures specific settings related to agents;

FIG. 6 is a simplified block diagram of data structures used to maintain a list of confirmed bookings and a standby list of participants waiting for cancellations, in the Junglebee server FIG. 1;

FIG. 7 is a flowchart of the steps taken by the server FIG. 1, upon cancellation of a booking, to automatically confirm a standby booking as depicted in FIG. 6.

FIG. 8 is an exemplary schematic illustration of a user interface for tour suppliers depicting information related to tours;

FIG. 9 is a simplified block diagram illustrating multi-destination tours and vehicle sharing in an exemplary embodiments of the present invention;

FIG. 10 is an exemplary user interface screen illustrating a payment dashboard;

FIG. 11 is an exemplary user interface screen of an app running on one of the computing devices used in FIG. 1;

FIG. 12 is another exemplary user interface screen of an app running on one of the computing devices used in FIG. 1; and

FIG. 13 is an exemplary user interface window running a widget installed on a website of an agent or a supplier executing on one of the computing devices of FIG. 1.

### DESCRIPTION OF EMBODIMENTS

A description of various embodiments of the present invention for a booking system, including a specific embodiment known as Junglebee Platform™, is provided. The booking system includes a web-based software platform that allows tour suppliers, travel agents and others to view and book in real time, local activities at traveler destinations such as tours, excursions, catamaran cruises, local activities, tickets to local shows and amusement parks and the like.

In this disclosure, the use of the word “a” or “an” when used herein in conjunction with the term “comprising” may mean “one,” but it is also consistent with the meaning of “one or more,” “at least one” and “one or more than one.” Any element expressed in the singular form also encompasses its plural form. Any element expressed in the plural form also encompasses its singular form. The term “plurality” as used herein means more than one, for example, two or more, three or more, four or more, and the like. Directional terms such as “top,” “bottom,” “upwards,” “downwards,” “vertically,” and “laterally” are used for the purpose of providing relative reference only, and are not intended to suggest any limitations on how any article is to be positioned during use, or to be mounted in an assembly or relative to an environment.

The terms “comprising”, “having”, “including”, and “containing”, and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method, or use functions. The term “consisting of” when used herein in connection with a composition, use, or method, excludes the presence of additional elements and/or method steps.

Embodiments of the present invention utilize computing devices that are interconnected through a network and a customized software that enables real time features that can be used by tour suppliers and travel agents to manage local attractions. The booking platform or system allows agents to print tickets as needed, and permits operators to edit prices or rates for adjusting mark-ups, and for operators to see a weekly schedule.

Tour suppliers are also known as show companies, event companies, and amusement parks. Agents are often also known as online activity specialists (OAS), online travel agencies (OTA), travel agents/agencies and activity desks (set up either independently or alternately as part of hotels or cruise ships). Tour suppliers and agents can see, in real time, space availability for tours, excursions, activities, tickets to shows and amusement parks, and book tours or activities using the system.

### System Architecture

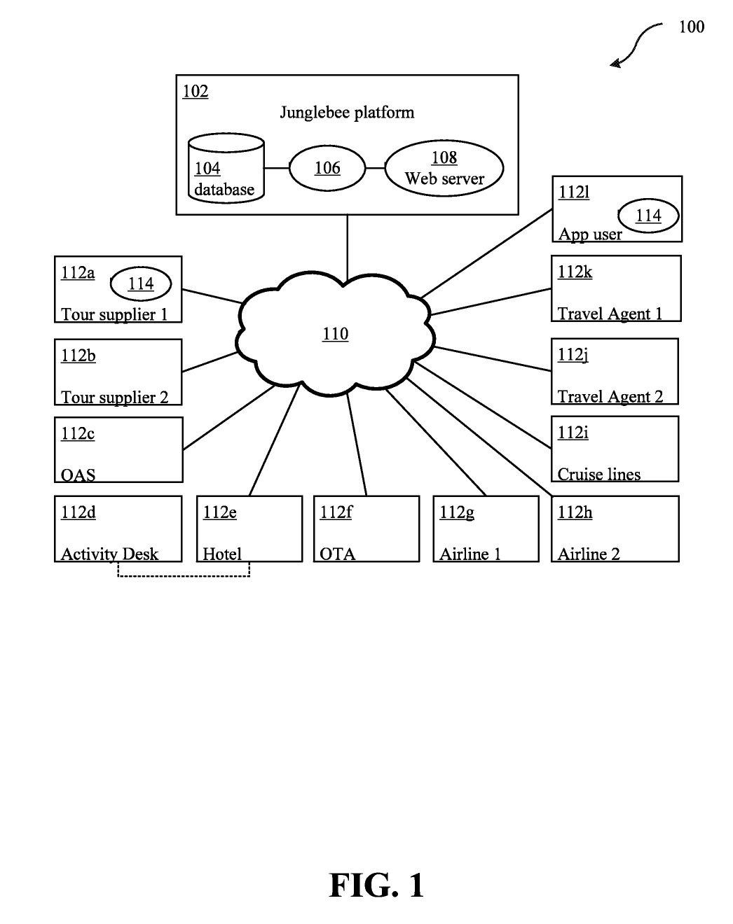

FIG. 1 depicts a simplified block diagram of a system 100 exemplary of an embodiment of the present invention. As depicted, the system 100 includes a computing system in the form of a server 102 interconnected to computing devices 112a to 1121 (individually and collectively, computing devices 112) via a network 110 such as the Internet or another wide area network, campus area network, local area network, or the like. Computing devices 112 may be used, for example, by tour suppliers, travel agents, online travel agencies (e.g., Expedia, booking.com), online activity specialists (OAS), hotels, cruise lines, airlines, activity desks and the like. An example of server 102 is the Junglebee Platform™ from Junglebee Inc, the assignee of the present invention.

As depicted in FIG. 1, computing devices 112a, 112b may be used by a first and second tour supplier respectively, while computing devices 112k, 112j may be used by a first travel agent and a second travel agent respectively. Of course, computing devices 112a, 112b need not be designated tour supplier computers, and similarly computing devices 112j, 112k need not be designated agent computers but may be used by any authenticated user. As will be detailed later, the server 102 may enable common features when a user logs into the server 102, but may selectively enable role specific features that are peculiar to the role of an agent if the user is an agent, or enable role specific features that are peculiar to operators if the user is an operator, and so on, based on the logged-in user's profile. Some users may have a hybrid profile allowing them to have multiple roles. For example, some users can be both agents and tour suppliers, and thus the server 102 provides them with access to all of the features enabled for agents as well as all of the features enabled for travel agents. Computing device 112l may be used by an app user as will explained later. Computing device 112l may be a smartphone and typically runs a mobile application code in the form of an app 114, which is customized for the hardware and operating system environment of the device 112l.

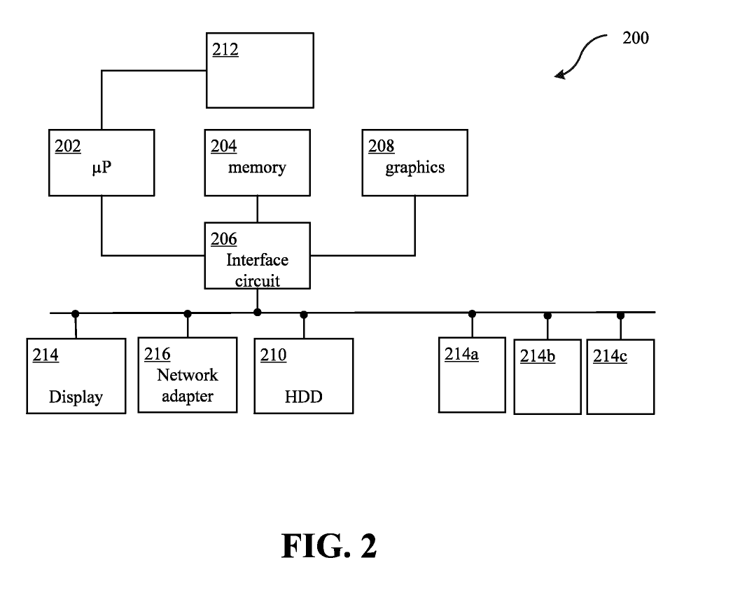

Each of the computing devices 112 may be in the form of a laptop computer, a desktop personal computer, a tablet computer, a smart-phone, or any other suitable computing device as will be described with reference to FIG. 2 later.

The server 102 includes software components such as a database 104, an application server 106 containing application server software or the business rules, and a web-server 108. The database 104, application server 106 and web-server 108 may represent parts of the data layer, business logic layer, and presentation layers (or tiers) respectively, as is typical in a layered or multi-tier software architecture.

The server side computing system depicted as server 102 may be in the form of a single computer as shown for ease of illustration in FIG. 1. In other typical embodiments, the server side computing system comprises a network of computers (e.g. database server computer, application logic server computer, web-server computer) or a cloud service that utilizes a large network of server computers (e.g. multiple database server computers, application logic server computers, and web-server computers), that collectively host multiple instances of application logic server software, database software, and web-server software.

The system 100 may additionally interact with other servers including an email server, a chat server, file server, cloud storage server and/or other servers to provide communication, archiving, backup and other auxiliary services including web services and other software as a service offerings. In some other embodiments, the system does not include a separate web-server software and a native client or app (e.g. app 114) running on devices 112 may communicate directly with application server 106 and/or database 104 in a client-server architecture.

### Computing Device Hardware

FIG. 2 depicts a simplified block diagram of computing device hardware 200, exemplary of an embodiment of server 102 or each of computing devices 112. As shown, hardware 200 includes a processor 202 such as a microprocessor or central processing unit (CPU) and memory 204 interconnected by an interface circuit 206. In the depicted embodiment, the processor 202 is interconnected to battery 212. The interface circuit 206 also interconnects input and output (I/O) components such a display 214 which may be a touch screen, a network adapter 216, as storage 210 and optionally one or more additional peripherals 214a to 214c (individually and collectively, peripherals 214) that may include a keyboard, a camera, a scanner, a touch panel, a joystick, an electronic mouse, touch screen, track-pad, or other pointing devices, and the like.

Memory 204 may be in the form of volatile memory or a combination of volatile and non-volatile memory, including for example, dynamic or static random access memory (RAM), read-only memory (ROM), flash memory, solid state memory and the like.

Storage 210 is typically non-volatile and may be a hard-disk drive (HDD), a solid state drive (SSD), EEPROM, CD-ROM, DVD, or any other suitable data storage element or medium, readable by processor 202.

The interface circuit 206 may include system bus coupling the various computer components or peripherals 214 to the processor 202. Many types of interface circuits are known in the laptop and desktop industry including ISA (Industry Standard Architecture), MCA (Micro Channel Architecture), EISA (Extended Industry Standard Architecture), VLB (VESA Local Bus), PCI (Peripheral Component Interconnect), PCI-X (Peripheral Component Interconnect Extended), AGP (Accelerated Graphics Port), PCIe (Peripheral Component Interconnect Express) and the like.

The network adapter 216 may be a wired or wireless, internal or external, which allows communication with other computers through a data network such as network 110. The network adapter 216 in computing devices 112 and/or server 102 may permit wired or wireless connections to an Ethernet, Wi-Fi, Bluetooth, cellular network and/or other suitable networks, thereby enabling connection to servers, shared or remote drives, one or more networked computer resources, or other networked devices, I/O peripherals and the like. Many types of computing devices 112 having suitable network adapters 216, and further equipped with mobile or desktop browser or other native client software or apps that may be characterized as thin-client, rich-client or hybrid applications, as will be well known to those skilled in the art.

### Software Architecture

As noted above, the system 100 may include presentation software components including web-server software 108 running on server 102, and browser software running in computing devices 112. The web-server software 108 may, for example, include the Apache HTTP Server or the Internet Information Server (IIS) and other web services, and allows browser software (e.g., Chrome™, Internet Explorer™, Mozilla Firefox™, Safari™ etc. in their desktop or mobile versions, native applications or apps) running on computing devices 112 to access the server 102 through the network 110. Server 102 may be accessed via the ubiquitous Hypertext Transfer Protocol (HTTP) or its secure version (HTTPS) via web server 108 for data entry, data editing, report generation, account configuration, changing settings, booking, deleting, managing lists, and various other activities enabled by the Junglebee Platform in the form of server 102, as will be described later.

The application server 106 executing on server 102 in FIG. 1 implements the application logic for system 100. The application server 106 may be implemented as software components, services or server software or other software components forming part of the program that encodes specific real-world business rules determining the creation, manipulation, alteration, generation and verification of data using data received from computing devices 112 or retrieved from database 104. The services in application server 106 including one or more messaging services that allow chat messages or other types of messages to be exchanged between two or more of computing devices 112 running an app 114 having a corresponding messaging client or chat client.

Database 104 provides storage for persistent data. As is well known, persistent data is often required for applications that reuse saved data across multiple sessions or invocations. Database 104 may be relational database management software (RDBMS) such as the Oracle server, the Microsoft SQL Server database, the DB2 server, MySQL server or an alternative type of database such as an object-oriented database server software.

As noted above, the server 102 can include a separate database server hardware to host the database 104 software, a separate application server computer (not shown) or a business logic server to host the application server 106. The computing devices used for server 102 or as computing devices 112 may include server class computers, workstations, powerful desktop personal computers, or any other suitable computing device. Computing devices 112 may be handheld mobile electronic devices. Database software 104 may be implemented as an encrypted database.

In operation, system 100 may be used by various parties as identified in FIG. 1. All users of the system 100 may thus have a direct, real time information regarding the availability of spaces on tours or other bookable activities listed in server 102 and accessed via a web browser or app running on any of the computing devices 112, so that when operators and agents reserve a certain amount of spots or spaces on an activity such as tour, then all other users see the update immediately. As noted above, the computing devices 112 may be a smart-phone, and instead of a traditional web-browser, either a mobile browser software (such as Safari™ for iOS™, or Chrome™ for Android™), or more conveniently via a smart-phone application or app can be used to access the server 102 from a smart-phone over network 110.

In one embodiment, the amount of space available for a given tour is provided in real time to every user, so that there is no difference in amount of spaces that can be booked by users. However, in an alternate embodiment, space availability per tour or per activity may be controlled or limited by tour suppliers. For example, in some embodiments a tour supplier can share space among multiple tours, while in other embodiments the tour supplier can block a certain number of spaces on a particular tour so that agents or tourists are not able to book it independently.

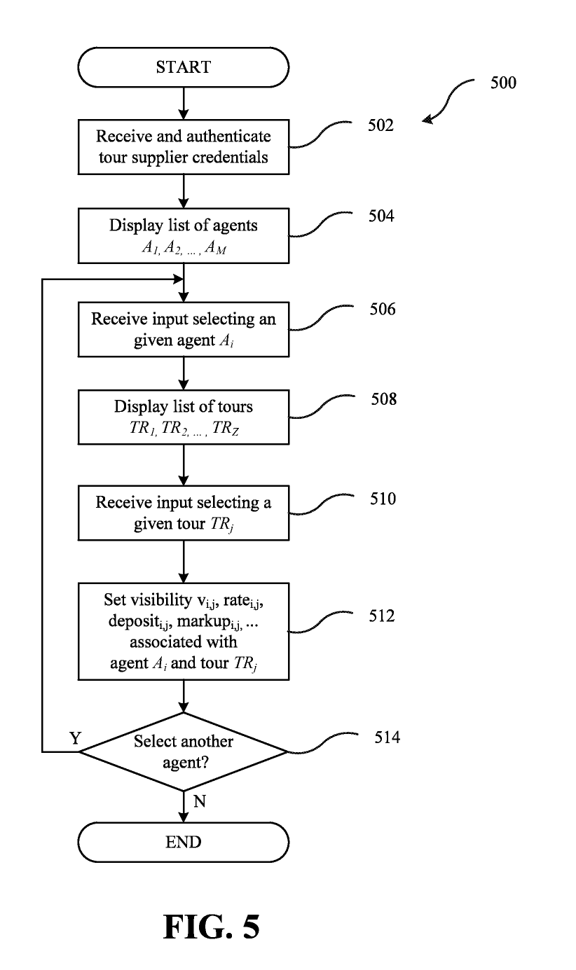

Tour suppliers are able to setup specific settings per agent such as: rates; deposit; and markups as will be discussed later with reference to FIG. 5. This allows an agent to set his or her own higher rate. In some embodiments, the agent's margin may be required to be positive or at least zero, so that the rate charged by the agent is not lower than the rate set by the tour supplier. In other embodiments, the agent may be completely free to set any rate he or she likes. Tour suppliers may also choose whether a particular agent can see their company through the Junglebee server 102; and choose which tours are to be made bookable in their company.

In one embodiment, the system 100 may be used by just tour suppliers and agents to see, in real time, space availability for tours, excursions, activities, tickets to shows and amusement parks, and book tours or activities using the system. Real-time is defined as pertaining to a data-processing system that controls an ongoing process and delivers its outputs (or controls its inputs) not later than the time when these are needed for effective control, according to one accepted definition in the McGraw-Hill Dictionary of Scientific and Technical Terms (6^{th} ed.). Such definitions are used, for instance, in airline reservations booking and chemical processes control.

Accordingly, the user interface to the Junglebee web application running on server 102 may be presented in at least two different user interface types such that a first user interface is presented for tour suppliers and a second user interface is presented for travel agents.

### Tour Supplier User Interface

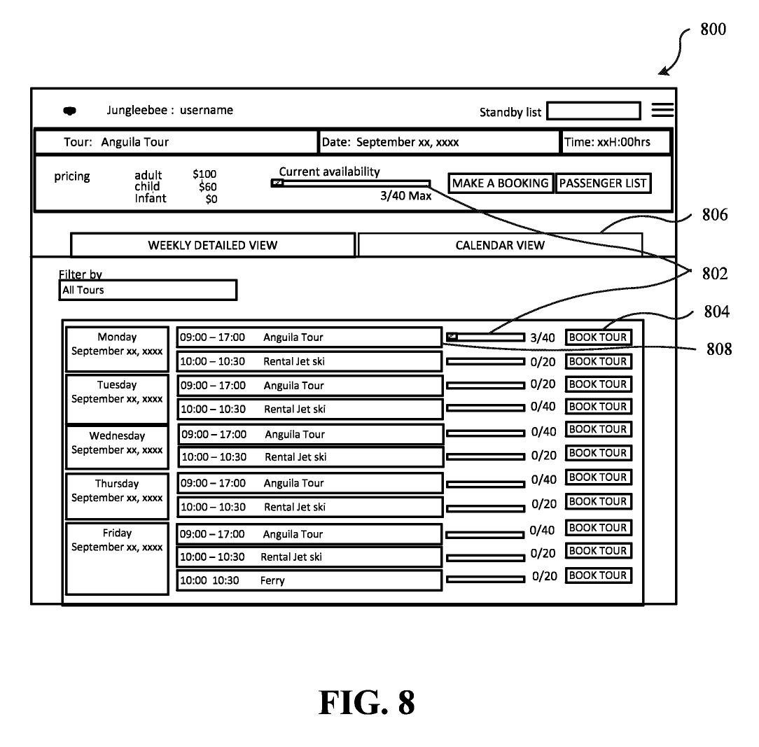

Upon logging into the server 102, tour suppliers are able to see the next several days of their schedule (e.g., their next seven day schedule), for all their tours and the respective time slots, including the amount of spaces available, on a page known as the dashboard. FIG. 8 depicts an illustration of an exemplary page 800. A slider handle 802 may be automatically set by server 102, to visually depict vehicle capacity, number of spaces booked and number of spaces available in the corresponding trip. A button 804 may be pressed by a user to book the trip. A tab control 806 allows the selection of a weekly detailed view, or a calendar view in this exemplary embodiment.

Time slot indictors 808 are arranged so that each timeslot can be booked or further visited to view a passenger or participant list that contains all the booking details per customer reservation along with the option to download to a spreadsheet representing a passenger list in one of many common formats such as a Microsoft Excel®, Google Sheet, Apple Numbers®, comma separated values (CSV) files, etc.

Tour suppliers can associate a custom color with each of their tours. The colors are readily visible in the tour supplier user interface or dashboard when a user inspects a daily or a weekly schedule. Advantageously, color coding tours allows tour supplier to quickly observe which tours are scheduled to go out in his or her schedule at a glance.

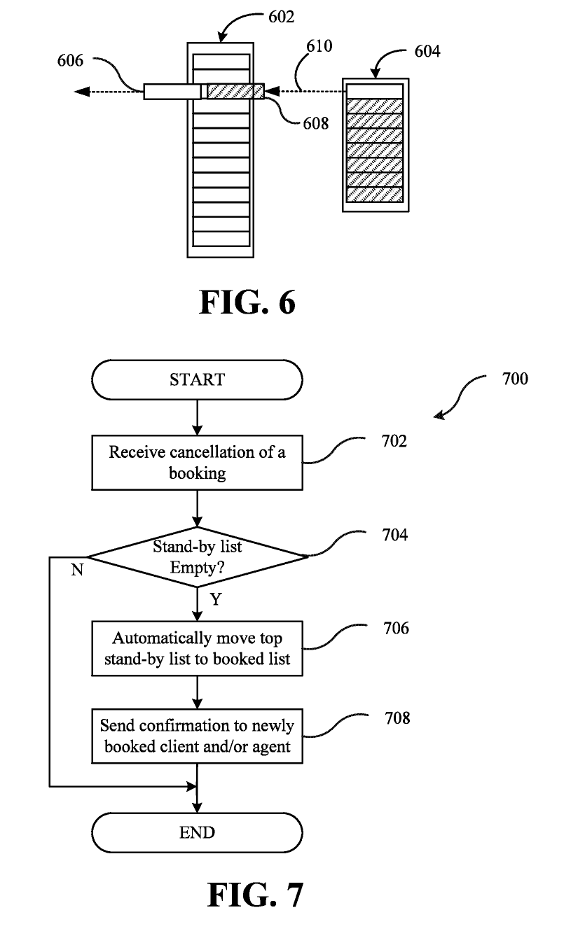

Furthermore, tour suppliers are able to use a standby list, which is displayed in a special page when accessing the Junglebee server 102. Standby lists are discussed in detail later with reference to FIGS. 6-7. If a booking for a given tour timeslot has been cancelled, deleted or the tour supplier does not quite know what to do with the booking, it can be placed in the standby list while the tour supplier decides what to do with the booking or contact the customers.

Tour suppliers are able to utilize a “customer search” feature located in the dashboard. They can search for a customer immediately and view all booking details. With each booking, a tour supplier can print tickets; edit the booking's date, time, amount of persons, tour, add-ons, notes, customer details; send to standby list; cancel a booking and the like.

Tour suppliers are able to pull several reports including: audit trail; daily intake; booking report; agency report and the like. The audit trail report may show every single transaction handled per employee on a daily, weekly, monthly or custom interval basis.

The daily intake report may show how much money each employee collected in total per booking on a daily, weekly, monthly or custom interval basis. The booking report may show how much bookings you made per tour and income collected.

The agency report may show how many bookings were reserved by each or all agencies and agents on the basis of predefined time periods or intervals such as daily, weekly, monthly or on a custom period basis.

In some embodiments, after a tour supplier or supplier receives a booking via the Junglebee platform, the tour supplier can then send a message of acknowledgment, thanks or appreciation via electronic means such as email, text message, chat message, short message service (SMS) messages, Facebook® message, Twitter™ tweet, and the like.

In some specific exemplary embodiments, the tour suppliers automatically receive an email message indicative of a new booking, so the tour suppliers can simply reply to the received email message in order to send a message of acknowledgement, thanks or appreciation. In other embodiments, a dedicated button on the “Booking Details” page in Junglebee platform may be used to send a quick acknowledgement or a “thank you/appreciation” message to the agent. The acknowledgement message can be a simple emoticon but also a text message or an SMS message.

In the above embodiments, the agent interface includes a special section where agents can receive messages. Agents can then open the message received, and see the content of message sent by the tour supplier/supplier along with a brief summary of the booking made and information about the sender. This feature introduces a human element to the Junglebee platform.

### Agent User Interface and Reports

The Junglebee platform on server 102 presents, a login window, and upon an agent logging in, his or her dashboard is presented allowing the logged-in user to view all tours that are configured to be viewable to the logged-in agent. These viewable tours can be filtered by category or searched under various other criteria.

Each tour may be selected by clicking on in dashboard using a mouse, keyboard, finger on touch-enable devices, or any other input device that may be part of peripherals 214. Selecting a tour may display a booking form that contains a schedule of the next several days (e.g., seven days) and availability. In exemplary embodiments, a user who is not the tour supplier for the selected tour such as an agent, cannot see exact amount of space available. The user must first size of the group or the number of participants. The schedule will then show which time slots are available to be booked based on the size of the group. Advantageously, the system provides tour suppliers management control over their spaces privately, without having to disclose space related information to agents. There is also a “tour details” tab that contains all important information about a particular tour.

Agents are also able to utilize the “customer search” feature located in the agent dashboard—just like tour suppliers. Agents can search for a customer immediately and view all booking details. For each booking, an agent may print a ticket using printer 212; edit the bookings parameters such as date, time, number of persons on the tour, tour type, add-ons, notes and customer details, and may also cancel the booking.

Agents are also able to pull several reports including: audit trail; daily intake; booking report; agency report and the like in manners similar to those described above for tour suppliers.

Accordingly, the agency audit trail report may show every single transaction handled per employee on a daily, weekly, monthly or custom interval basis; while the agency daily intake report may show how much money each employee collected in total per booking on a daily, weekly, monthly or custom interval basis.

The agency booking report may show how much bookings you made per tour and income collected. The agency report may show how much were received by each or all agencies and agents on a daily, weekly, monthly or custom basis.

There may be several common user interface features and associated functions that are available to all accounts. For example, both tour suppliers and agents may be able to access their respective “My Account” settings page, where all company details may be set up.

### Hybrid Accounts

As noted earlier, some embodiments of the Junglebee platform on server 102 permit a particular user to have a hybrid account, allowing him or her to be both a tour supplier and also an agent. In this case, the user is provided added features that allow flexibility in acting as both a tour supplier and agent.

When a company is both an agent and a tour supplier, a user associated with the company may book tours in the agent section, and have all of the transactions and actions show up in the company's tour supplier reports as discussed above. The Junglebee platform on server 102 allows any user to associate a payment or voucher to an agent in the payment's section. In some embodiments, this may also be done by an agent.

The payment section allows any user to invite an agent to the Junglebee platform server 102 should they need to. The invited agent will receive an automatic communication such as email or text or chat message, which contains his or her login details.

At predetermined intervals, for example every five (5) or six (6) hours, prior to a tour starting, the platform server 102 may send a spreadsheet containing a passenger list (per tour), via email to the tour supplier.

In addition, all users are able to sync their account bookings to mobile, tablet or computer supported calendars. The tours available on server 102 may thus be synced with the calendar applications executing on computing devices 112.

### Real Time Access

The Junglebee platform on server 102 provides real time availability, information such as customer details, tour details; and bookings for tours, excursions, activities, rentals, private charters, tickets to shows and amusement parks between tour suppliers, travel agents, online travel agencies such as Expedia, booking.com, etc., online activity specialists, hotels, cruise lines, airlines, and activity desks. Each of these parties is able to see, in real time, any changes in the spaces available for these activities using the Junglebee platform server 102.

Any transaction on server 102 that affects the availability of space on a particular tour is immediately available for inspection by others. For example, if a tour supplier using computing device 112a cancels a booking on a particular tour that was full, thus freeing up x spaces, then the availability of these x spaces can be seen by travel agent that is simultaneously logged onto the Junglebee server 102 from computing device 112k.

Similarly, if a tour supplier cancels a tour or blocks further booking on the tour, all other users logged on the Junglebee server 102 would immediately see that the tour is cancelled or no longer available for booking.

This is advantageous in many tourist destinations where local tour suppliers and local agents rely on telephone calls and emails to arrange local activities. Such means of communication suffer from latency, lack automation and are prone to human error. The Junglebee server 102 offers a reliable, real time, automated system to avoid many of the delays and inefficiencies associated with existing methods.

Moreover, the Junglebee server 102 may be extended to interface with or integrate with existing global distribution systems (GDS) that already enable automated transactions between travel service providers such as airlines, hotels and car rental companies on the one hand, and travel agencies on the other. The Junglebee server 102 provides the missing piece that allows agents for local attractions and local tour suppliers to work together seamlessly in an integrated, automated system in real time to provide service for tourists and local visitors at tourist destinations.

### Short-Notice Reservation Processing

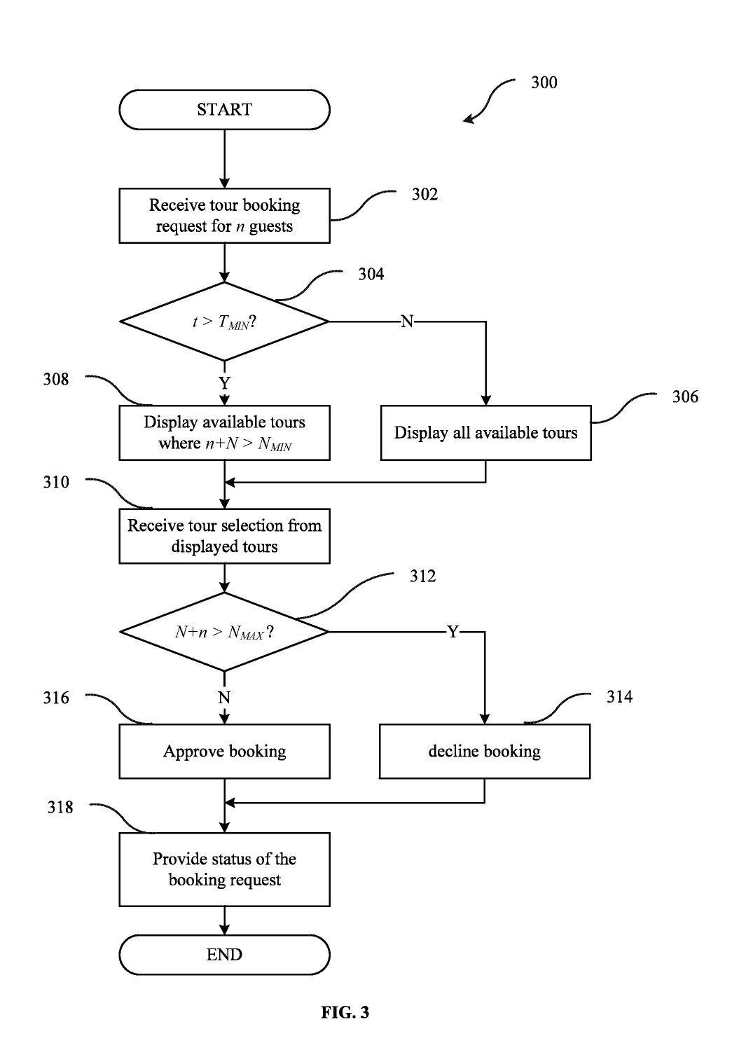

In one embodiment, a tour may be said to be available if the tour has not left; the tour has at least one free space to be booked; and the tour has not been cancelled. If an available tour does not reach a minimum quantity of booked participants by a certain time before departure, then Junglebee server 102 may block further bookings on the tour unless the next booking request has enough guests to meet the minimum quantity of participants criterion. This is illustrated below with the aid of FIG. 3.

FIG. 3 depicts a flowchart 300 of the steps taken by Junglebee server 102, as it relates to the minimum quantity of participants criterion.

Let t denote the current booking request time; let N denote the number of spaces already taken up in a given tour at time t; let N_{MAX} denote the maximum number of spaces available in the given tour to be taken up by participants; let n denote the number of participants or guests included in the current booking request; and let T_{MIN} denote a cut-off time by which a certain minimum number bookings N_{MIN} is desired; and let and let T_{START} denote the tour start time.

Referring to FIG. 3, at step 302, the server 102 receives a tour booking request for n guests or participants. The server 102 checks if the current time t is earlier or later than the cut-off time of T_{MIN} (step 304) by which time the minimum number of participants N_{MIN} should be booked.

If the booking request time t is before or earlier than the cut-off time T_{MIN} (step 304), then the server 102, displays all available tours (step 306). As noted above, a tour is deemed available if it has not yet departed, has at least one space left on it, and has not been cancelled. The server 102 then receives a selection from the displayed tours (step 310).

If however the booking request time t is after the cut-off time T_{MIN} (step 304), then the server 102, displays only those available tours (step 308) that have enough spaces already booked so that together with the additional n participants, can meet the criterion.

If the selected tour has enough space to accommodate the booking request, i.e., if n≤N_{MAX}−N or in other words, if N+n≤N_{MAX} leading to a “yes” (Y) at step 312, then the server 102 approves the booking (step 316). If however, N+n>N_{MAX} leading to a “no” (N) at step 312 then the booking request is declined (step 314). A status indication of whether the booking is approved or declined is then provided at step 318.

For a more concrete example, suppose that a tour requires a minimum of ten (10) people booked, six (6) hours before its departure time of 3:00 PM so that N_{MIN}=10; T_{START}=3:00 PM; and T_{MIN}=9:00 AM (six hours before 3:00 PM). In accordance with flowchart 300, up to 9:00 AM any group size can book provided there is space available (i.e., n≤N_{MAX}). Now, suppose that the tour already has four (4) confirmed bookings by 9:00 AM (i.e., N=4). Then afterwards the tour will only become available for booking requests with large enough sizes, i.e., for booking requests where n≥6.

### Short Notice 2 Step Reservation Procedure

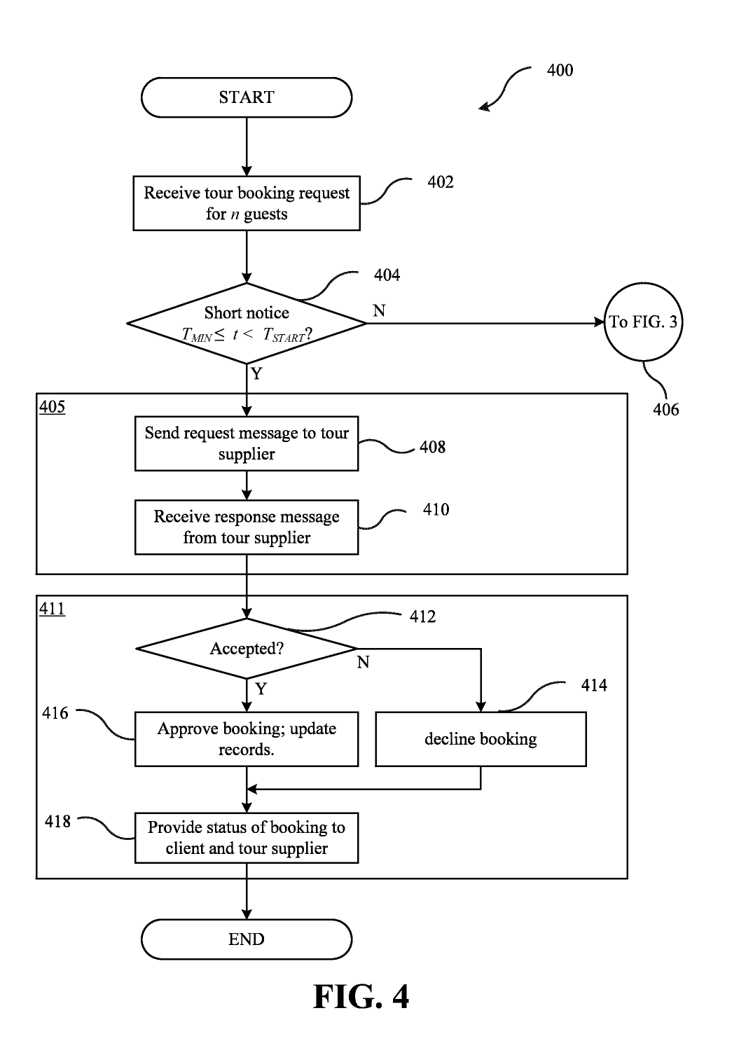

In another embodiment of the present invention, tour suppliers may set a minimum time required to book a tour in advance. In Junglebee server 102, a tour supplier may further choose to set up a “short-notice two-step reservation procedure”. This allows the tour suppliers to accept or decline short-notice tour bookings. The operation of one embodiment of this process is described below with reference to FIG. 4.

FIG. 4 depicts a flowchart 400 of the steps taken by Junglebee server 102, for a two-step short-notice reservation. At step 402, the server receives a tour booking request for n guests or participants. The server 102 checks if this is a short-notice booking at step 404, by checking for example, if the current time t is on or after the cut-off time of T_{MIN} but before the tour start time T_{START}.

If the booking request is not a short-notice booking then the steps of FIG. 3 may be carried out instead (step 406). If the booking request is indeed a short-notice booking (step 404), then the server 102, executes the first step 405 of the exemplary two-step procedure.

In the first step 405 of the two-step procedure, server 102 sends the booking request to the tour supplier to approve or decline (step 408) and then receives a message back from the tour supplier (step 410). The message exchange in steps 408, 410 may be carried out using any wired or wireless data communication means such as email, phone, chat, text message, or a Junglebee custom user interface executing on server 102.

After receiving a message from the tour supplier, the server 102, then executes the second step 411 of the two-step procedure. If the tour is accepted (step 412) then the server 102 approves the booking on the Junglebee system (step 416) and updates related records on database 104. Although database 104 may be a typical relational database management system, in specific exemplary embodiments, a person of skill would understand that different data storage and retrieval technologies, such as hardware accelerated appliances, massively parallel processing, map-reduce, Hadoop and other NoSQl approaches, may be used in other embodiments. If however, the tour is declined by the tour supplier (step 412) then the server 102 also declines the booking and the booking is not registered in the server 102.

In alternative embodiments, a time-out may also be included so that if a response is not received within a predetermined time from the tour supplier at step 410, then server 102 assumes that the booking has not been accepted by the tour supplier, and the flowchart 400 proceeds to decline the booking at step 414.

The status of the booking request is then provided (step 418), either in the form of confirmation messages to the client and tour supplier; or via an indication that the booking is declined.

Subject to exceptions of special procedures such as those discussed with reference to FIG. 4, booking requests made using the Junglebee server 102 are confirmed in real time. In exemplary embodiments, the process of confirming bookings is thus instantaneous, limited only by the latency of network 110 and processing capabilities of the server 102 and computing devices 112.

A tour supplier is able to sell directly to customers or to agents using the Junglebee platform on server 102.

### Special Pricing Per Agent Company

As noted above, an agent logged into the server 102 is able to see availability of space in tours of interest, in real time. An agent may be any authorized employee of an agency registered with server 102 and given appropriate credentials for logging into the Junglebee server 102.

In addition, the Junglebee platform on server 102 allows the tour supplier to setup or configure specific settings or parameters as it relates to agents that are allowed to sell spaces or seats on the tour supplier's tours.

FIG. 5 depicts a flowchart 500 of the steps taken by Junglebee server 102, when an activity operator or a tour supplier configures specific settings related to agents.

At step 502, the server 102 receives and authenticates the tour supplier credentials. After authentication, the server 102 displays a list of M agents A₁, A₂, . . . A_{M} at step 504. The server may then receive input, representative of a selection of one the M agents Aᵢ (where 1≤i≤M) by the tour supplier (step 506).

Next, at step 508, the server may display a list of Z available tours TR₁, TR₂, . . . TR_{Z}. The server 102 may then receive another input, representative of a selection of one the Z tours, TRⱼ (where 1≤j≤Z) provided by the tour supplier (step 510).

The Server 102 then sets (step 512), based on input from the tour supplier, various parameters including visibility v_{i,j}, that is, whether the agent Aᵢ can see or book the tour TRⱼ; the rate r_{i,j}, deposit d_{i,j}, mark-up m_{i,j}, etc. associated with the selected agent Aᵢ for the selected tour TRⱼ. In some embodiments, in addition to the ability to set the visibility v_{i,j}, of individual tours, the tour supplier company itself may be made invisible to a particular agent entirely.

At step 514, the server 102 checks if the operator wishes to select another agent and if so continues the process back at step 506, but otherwise the process is terminated.

### Stand-by List for Tours

The Junglebee server 102 may maintain a stand-by list for one or more tours or other activities. FIG. 6 depicts a simplified block diagram of data structures used to maintain a list 602 of confirmed bookings and a standby list 604 of bookings by participants waiting for cancellations.

Agents may be able to book customers on tours that allow a stand-by list. Bookings that are placed in stand-by list 604 do not take space on the confirmed tour list 602. If there is any opening in list 602, the stand-by bookings automatically take the available space and become automatically confirmed.

Upon cancellation of a confirmed booking, the server 102 may select the booking identifier 608 from the top of the standby list 604 automatically transfer or move the booking to the confirmed bookings list 602 as indicated by arrow 610, thereby automatically confirming the booking. All partied are then notified. If no space opens up and the tour goes out, bookings on list 604 are automatically cancelled and all parties are notified.

FIG. 7 depicts a flowchart 700 summarizing the steps taken by server 102 in operation described above. As depicted, upon receiving a cancellation (step 702), the server 102 checks if the stand-by list is empty (step 704). If the standby list is empty (step 704), then the process terminates. However, if the standby list is not empty, the Junglebee server 102 moves the booking identifier 608 from the top of standby list 604, automatically to the confirmed bookings list 602 as shown in step 706. Confirmation is then message sent to the newly booked client and/or the agent associated with booking identifier 608 and others (step 708). The process 700 then terminates.

### Needs-Attention List:

An exemplary embodiment of the present invention includes a feature called “needs-attention list” which can be provided as a subset of the standby list discussed earlier above. This feature allows a user of the Junglebee system 100 to move a booking, to the needs-attention list in cases where booking cannot be accommodated on the tour on which it is currently booked but requires further scrutiny before being placed in another tour, or where there is no tour immediately available where the booking can be placed. If a user such as a tour supplier does not know what to do with such a booking, he or she can safely park the booking at the Needs-Attention list for later processing. Advantageously, placing a booking onto the Needs-Attention list immediately frees up spaces associated with the booking from the original tour to be reused by other bookings.

Bookings that are placed on the Needs-Attention list remain with all of their booking details including guest names and details, price, participants, date and time along with booking history and payment history. These bookings can thus be inserted into any new tour or timeslot by an agent or tour supplier, and consequently removed from the Needs-Attention list. An exemplary embodiments of the tour supplier user interface displays bookings within the Needs-Attention list.

### Custom Schedules:

Some embodiments of the present invention include schedules that can be setup as in one of two modes that may be referred to as “SET” and “FREE”. In one exemplary embodiment, SET schedules are standard, simple schedules in Junglebee™ in which a user sets up a tour every day for a set duration, at a specific time of the day. Alternately, the user can setup a tour only on specific day of the week. In yet another exemplary embodiment, the user sets up a tour for only one day in a given duration such as a year or a season. The schedule can be set to repeat or recur at regular intervals of days, weeks, months or other repeating intervals such as, for example, the first Saturday of every month, every other Wednesday or the like.

FREE schedules can be set to allow a charter duration (e.g., 12 minutes or 4 hours, etc.) within a predefined time window (e.g., between 09h00 and 17h00) in a selected day. An interval time can be set between successive charter durations such as a minimum of five (5) minutes or twenty (20) minutes. In operation, a user books a tour any time within the window, for the predefined charter duration. Junglebee server 102 may then apply the interval time once tour is over, so that next user books the next trip accordingly. Thus given the a window of 09h00 and 17h00, if the first tour is booked for 4 hours at 09h00 and the interval time is set to a minimum of 20 minutes, then Junglebee ensures that the next tour can only be booked at 13h20 by applying these settings. That is, the first 4-hour tour starts at 09h00 and ends at 13h00, and after a 20 minutes interval time is applied, the next booking cannot start earlier than 13h20.

### Vehicles and Order Thereof

In one exemplary embodiment of the present invention, in the system 100, each company account specifies the vehicles associated with the company. As noted earlier, both tour suppliers and agents can access their respective “My Account” settings page, where all company details are set up and updated. The term “vehicles”, in this context, includes one or more types of both motorized or non-motorized means of transportation such as limousines, buses, other automobiles; boats, catamarans, cruise ships, and other watercraft; helicopters, small planes, hot air balloons, and the like, available for use in tours, excursions or rides. Each vehicle can be given a custom name. A record of each vehicle can be stored in database 104. The stored information includes a unique identifier or set of identifiers, and an associated number of spaces or spots available for use by tourists, passengers or participants; and many other properties.

In some exemplary embodiments, a tour supplier can set the order of vehicles that are used for a given tour, private charter or rental. The order in which the vehicles are filled can be specified as a default order. The default order can be changed by the tour supplier by a custom order to be used for any given day. Some operators may have vehicles of different size, class, speed etc. while other operators may have a fairly uniform feature set for their vehicles. Many types of optimizations can be attempted with flexible arrangement of vehicle orders. In some cases, it may be beneficial to arrange for larger or smaller vehicles to be used, either earlier during the day or later, depending on peak times of demand, traffic considerations, unit cost, customer profile, and the like.

### Multi-Destination Tours and Vehicle Sharing:

Tours, private charters and rentals can each have a single destination or multiple destinations. In one embodiment, each destination in the Junglebee™ system 100 includes its own set of parameters such as custom schedules, vehicles, order of vehicles, description, participants, price, add-ons, important information, and photos. A destination, in this context, is very similar to a simple standard tour in Junglebee™. Tours can be nested together so that for example, a larger tour can include a first leg or trip to a primary destination, and additionally one of many secondary legs or trips to second destination from the primary destination. Embodiments of system 100 may thus include an advanced scheduling system that can accommodate booking nested tours involving primary trips followed by secondary trips, which may yet involve further tertiary trips, and the so on.

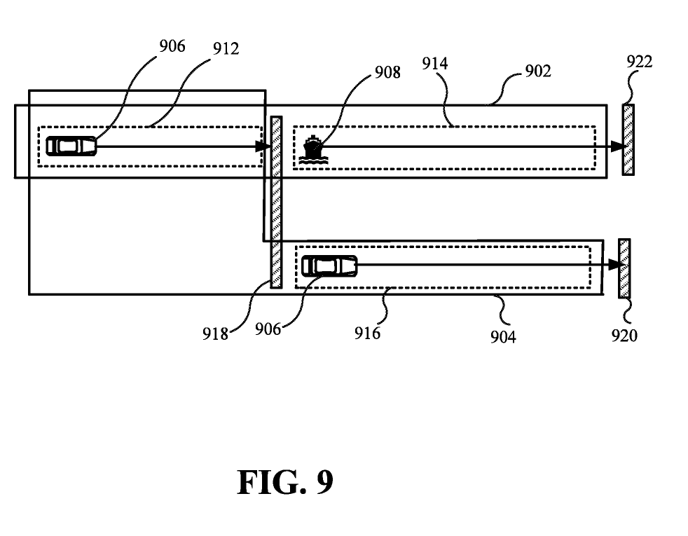

An exemplary scenario is illustrated schematically in FIG. 9. As shown, a first tour 902 and a second tour 904 each involve multiple stops or destinations. The first tour involves a first trip 912 to first destination 918 and a second trip 914 to a second destination 922. The second trip 904 involves the same first trip 912 to the first destination 918 but another second trip 916 to a second destination 920. As noted above, the trip 912 to destination 918, in this context, is basically a simple standard tour. However, it is nested within a larger tour 902.

Vehicles 906 and vehicle 908 are involved in trip 912 and trip 914 respectively. In this specific embodiment, vehicle 906 is an automobile and reused again in trip 916 while vehicle 908 may be a catamaran, a boat or even a cruise ship. In other embodiments, another vehicle may be used for trip 916 instead of reusing vehicle 906.

As will be appreciated, vehicles can be shared between tours, private charters and rentals that are maintained by the system 100. In the example depicted in FIG. 9, the same physical vehicle 906 is used for the first tour 912 can be made available for the subsequent trip 916 provided that the time durations for these two trips 912, 916 do not overlap.

As shown in FIG. 9, two nested tours such as trips 902, 904 can share a common sub-tour or trip such as trip 912, and thus a common vehicle 906 for their first trip, but may use different secondary trips 914, 916 using different vehicles 906, 908. Many sharing scenarios are thus possible with the Junglebee system which provides flexible advanced scheduling and vehicle fleet booking management.

### Referrals and Sources:

In some embodiments, an agent or a tour supplier can store the source or referral associated with a booking. In some embodiments, each agent and tour supplier maintains its own list of sources for its bookings. Maintaining a record of sources of each booking allows a company to aggregate individual bookings and trace them back to the sources. This further permits the company to tailor daily operations, offers of discounts, priority services, perks, and other incentives in a manner that strengthens business relationships with important sources that originate substantial volumes of its business.

An agent or tour supplier can add a source to any booking. Sources are custom information fields created per tour supplier company or agency. Each company can have its own list of sources. Sources are used to represent where the booking came from which is used for reporting purposes and good to know for day to day operations on the field. So if an agency was making bookings and representing many various companies with inbound guests, they could then associate each booking to the various companies that they handled bookings for.

### Offline Mode:

In one embodiment, the Junglebee app 114 running on handheld mobile devices 112 such as iPhone® from Apple or Android™ devices can work offline. As may be appreciated by persons skilled in the art, apps are typically well suited for offline mode operation for activities that do not require communication, while still capable of communicating with a web-server or web-service.

In one embodiment, the offline mode of operation allows a user to accept bookings by users. of course, in off-line mode, real time information from the server is not available. Booking related data or information received by the app is stored locally on device 112 using data structures that can be used to send information back to server 102 when connection is reestablished. The user interface of the app can look the same as when the app is online.

Offline mode can be initiated manually, or can automatically be triggered upon loss of connection to the server 102. Various configuration settings can also be set to allow offline operations depending on the number of spaces available or other parameters.

For example, a tour supplier can set his or her tour to be bookable in offline mode, only if ten (10) or more spots are available for his tour at the time the app goes offline. If the app goes offline at 14h00 and there were six (6) spaces left on the tour at the time, then tour would not be available for offline booking. However, if the app goes offline at 15h00 and there were ten (10) spots or more available on the tour, then the app allows bookings to be made offline.

If while offline, the offline booking specifies more spaces than are actually available on the real time server, when the app goes online, then the excess bookings made offline will be sent to the “Stand-By List” for the specific tour associated with the booking.

In one embodiment, as soon as there internet connection is restored, the app connects to the Junglebee servers and thereafter uploads all offline bookings to the server, and downloads the latest new data regarding information or availability of tours. In another embodiment, a user of computing device 112 manually causes the app to go online, after ensuring that internet connection has been restored.

### User Invitation Tool:

An exemplary embodiment of the Junglebee platform server 102 allows an existing user to invite and register a new account for a new user. The existing user can be a tour supplier or an agent. In one example, the existing user submits the full name, company name, an email and an optional message. The submitted information is received by the Junglebee server 102. Upon receiving the information, the server 102 automatically creates a new user account for the new user, and a company account for the new company.

The server 102 then sends an email message to the new user using the email address associated with the account. The email message includes the user's username, password and a custom message that explains how to gain access to services provided by the Junglebee platform.

In alternate embodiments, individual computers 112 may be designated with a particular profile and may be treated by the server 102 as either agent computers, tour supplier computers, hotel guest computers, and the like. Any user using such designated computers may thus be assumed by the server 102, to have the profile associated with the computer.

### Payout Dashboard

In accordance with one embodiment, server 102 may provide a payment service that enables users, that is suppliers and agents, to charge their customers via credit card or another payment system during the reservation process and allocate the amount charged between suppliers and agents.

The allocation may be based on a predetermined allocation scheme that is programmed into or stored in one or more of the server software components database 104, application server 106 and webserver 108.

In one specific embodiment, server 102 may execute a process in which a predetermined share of the tour price is charged upfront. The share charged (denoted y) may be a percentage that ranges from just over 0% up to and including 100% of the full amount of the tour price (i.e., 0%<y≤100%). The amount charged C may then be split, apportioned or divided between the agent and the supplier automatically by server 102. The respective share as a percentage, between the agent and the supplier may be expressed as a % (the commission percentage set in the Junglebee system for the agent), j % (the Junglebee system fee expressed as a percentage) and s % for the supplier which is the balance, so that a %+j %+s %=100%.

In one example, the full amount (100% of the tour price) is charged to the customer's credit card by the system, and the funds are split between suppliers and agents. In other examples, only 50% of the tour price may be charged, but it will be apportioned between the supplier and the agent in the same predetermined proportion, that is, the agent is allocated the predetermined commission rate, the system fee is allocated to the owner of system 100 and the balance is allocated to the tour supplier.

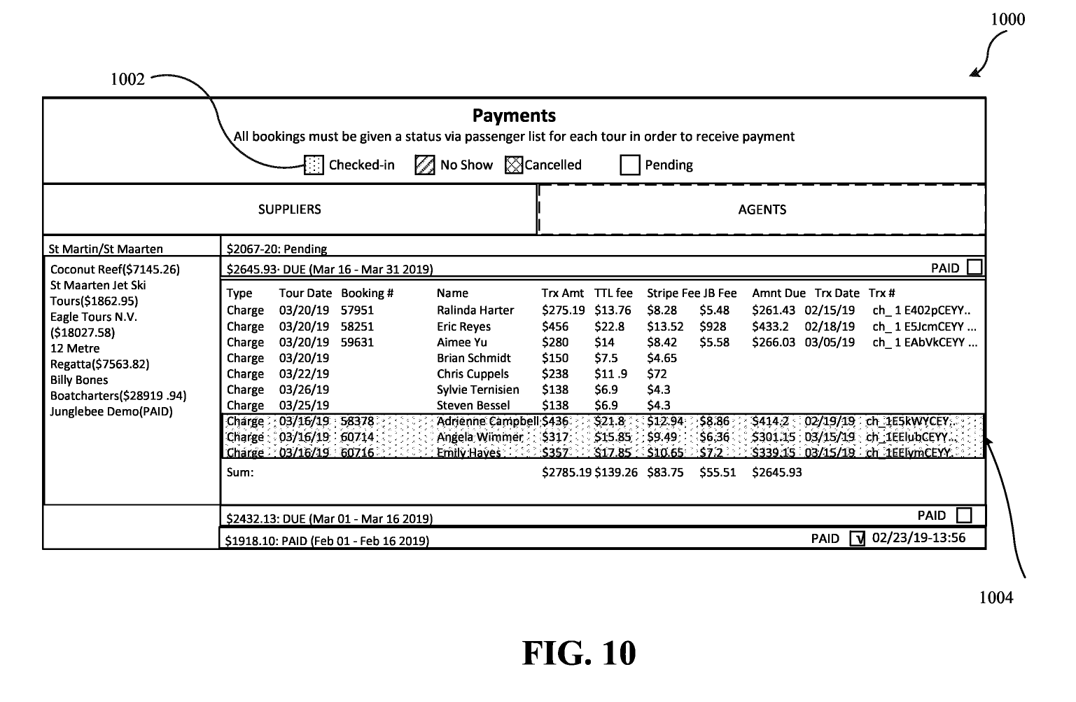

Agents and suppliers may be provided with a user interface called the payout dashboard that may be viewed to monitor accounts. An exemplary dashboard 1000 is shown in FIG. 10. The dashboard 1000 may be included as part of the reports section of the software and may allow viewing of the computed payments or receivables to the supplier or the agent in real time.

In some embodiments, some or all tours sold in the Junglebee system via payment service may be paid to suppliers and agents, only upon ensuring that the client or customer has received the service or participated in the tour. The booking function may be employed to check the booking status of a customer with respect to a tour. The supplier for the tour is required to update a status value for each booking. Exemplary status values include these listed below.

| Status | Meaning/Remark |
|---|---|
| Check-in | The guest(s) have arrived and is (are) on the tour. |
| No Show | The guest(s) did not show up. Based on the applicable |
| | cancellation policy, full refund, partial refund or no |
| | refund is given to the purchasing customer. |
| Cancelled | The booking has been cancelled by either the supplier, |
| | agent or customer prior to the tour starting. |
| Pending | Default status for bookings until changed to another |
| | status. |

A “Check-in”, “No Show”, or “Cancelled” status leads to the automatic calculation and payment of proceeds to the agent or supplier.

In the exemplary dashboard 1000 as shown in FIG. 10, status legends are shown corresponding to the table entries above. An exemplary status legend item 1002 indicates the visual representation for the “checked-in” status.

Accordingly, guests that have “checked-in” status are presented in a matching visual representation (i.e., shading or color) for easy identification of the checked-in booking records 1004.

### Website Widget for Agents

Embodiments of the present invention offer a website widget to suppliers. A website widget is a booking system interface to the Junglebee booking system 100 or specifically to the software components running on server 102, that suppliers can install on their own website with a simple script or plugin. This in turn activates a booking form or user interface on the supplier's website for their tours, which is connected to the host booking system 100.

Advantageously, the website widget of embodiments of the present invention differs from known scripts or plugins. In addition to being capable of being installed on a supplier's website, the exemplary widget can also be installed on an agent's website, thereby turning the agent's website (or any type of business website) into a booking platform for tours hosted on the Jungle platform server 102.

The exemplary website widget for agents enables an end user or a tourist to view and book tours from various suppliers; to search for tours according to tour categories (e.g., snorkeling, powerboats, catamarans, sailing, jet skiing, etc.); and to search for tours according to their group size based on real time space available on a given day.

Bookings are all processed directly with each supplier individually. In some embodiments, Junglebee server 102 will charge the end user (e.g., via credit card) separately for each booking belonging to different suppliers. The end user only transacts once using the system, but the proceeds are split at the backend (i.e., at server 102) as discussed earlier. This enables handling of each booking separately for the purposes of editing, charging and refunding.

Conveniently, agents and suppliers are not required to do anything once a booking is completed by the end user customer. For each booking, the Junglebee platform server 102 automatically sends a notification to both the supplier and agent that they have received a new booking. Furthermore, the Junglebee platform server 102 also sends the check-in email to the end user that provides all of the tour and check-in related information.

In some embodiments, the website widget offers a shopping cart to the end user customer, which allows the end user or tourist to add various tours from different suppliers before proceeding to checkout and finalizing payment. It is noteworthy that bookings by end users are processed instantly and sent to various suppliers directly. There is no intermediary holding the reservation and each reservation is instantly confirmed since it is based on real time availability. This often leads to efficiencies and lower transaction costs.

Agents and suppliers have access to these booking within the Junglebee platform on server 102. Advantageously, agents and suppliers can control which tours appear in their website and the order in which they appear within their instance of the web site widget, to the end user. Agents and suppliers can thus also remove tours from being shown on their website and perform other customizations. These customizations may include setting special pricings, custom deposit per agent, changing the name of a tour, etc.

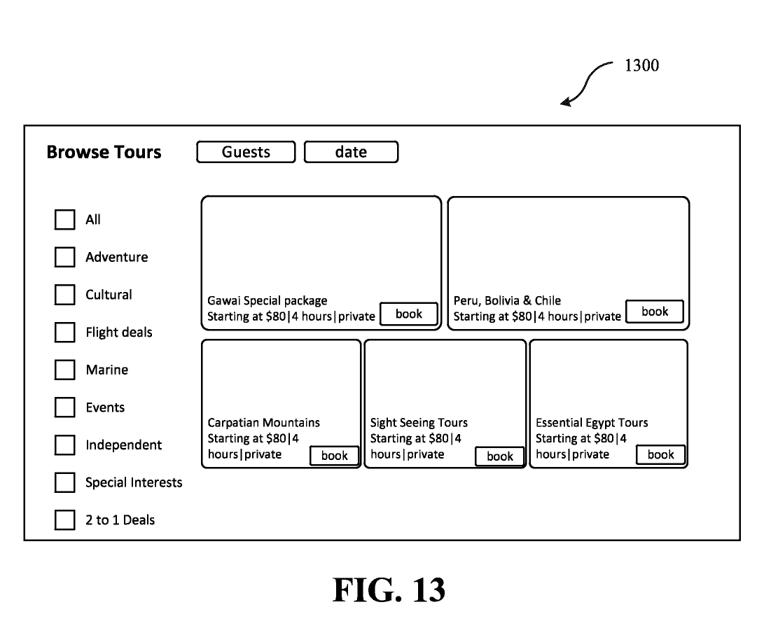

An exemplary user interface window 1300 for the widget is shown in FIG. 13 installed on a website of an agent or a supplier.

The script or widget may be provided in a non-transitory computer-readable medium such as a CD, DVD, USB stick, or downloaded from a server and installed. The non-transitory computer-readable medium may include processor executable installation instructions that, when executed by a computing device, causes the computing device to execute the steps of: receiving a request to install the web application; downloading the web application; downloading a uniform resource locator (URL) or more generally a Uniform Resource Identifier (URI) associated with the web application; installing the web application on the computing device; displaying, in the web application, the content of the URL or URI. The content of the URL or URI is provided by the server in the automated booking system 100 as described above. The non-transitory computer-readable medium may contain installing instructions that perform one or more of installing a plugin for a browser software; updating files at the computing device via a script; or updating header files for a website running at the computing device.

### Communication App

As noted above, the Junglebee system 100 includes computing devices 112 may be smart-phones running an app that can be used to access the server 102 from the smart-phone over network 110. Some embodiments of the present invention thus include a custom app that can run on one or more of iOS™, Android™ and other mobile operating systems for handheld mobile devices. Non-limiting examples of handheld electronic devices include smartphones (e.g. iPhone™, Blackberry™, Windows™ Phone, Android™ phone), media player devices, and any other mobile devices which combine one or more aspects or functions of the foregoing devices.

The custom app enables companies for specific industries to communicate between each other and even book services within the app. The app running on a device 112 accesses server 102 via the Hypertext Transfer Protocol (HTTP) or its secure version (HTTPS) for data entry, chat, messaging, booking, and other types of image or data viewing, uploading and editing. In other embodiments, the server 102 need not necessarily be accessed via HTTP or HTTPS, but instead any other suitable protocol may be used.

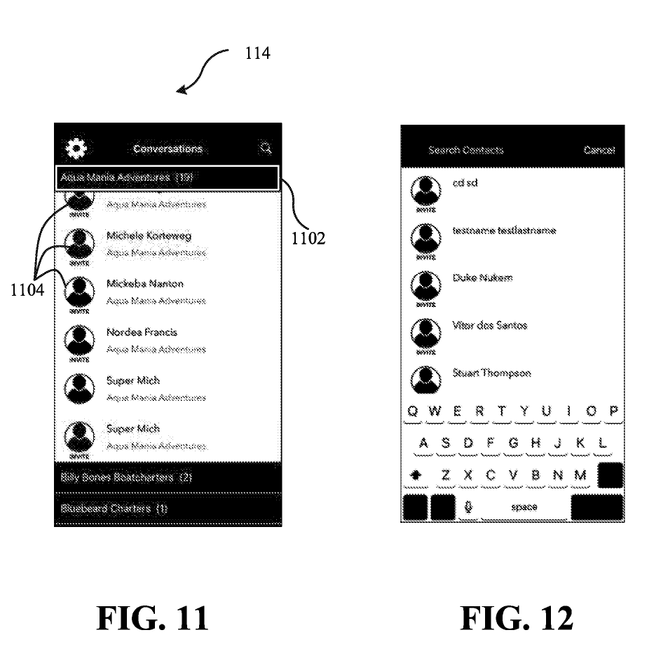

In operation, a user logs into the app, and thereafter can see in alphabetical order all the various company names. The logged in user may select on a particular company, for example by clicking or swiping on the name of the company. The app then displays all of the selected company's users or staff. An example of this is illustrated in FIG. 11.

As shown, when a button 1102 associated with the first company listed “Aqua Mania Adventures” is clicked, the users 1104 associated with the selected first company are displayed.

The user may choose to click on any one of the users or staff members to communicate directly via a chat module, with the selected person.

### App Features

Messaging and Booking

The chat or communication feature in the app 114 between users enables each party to book the services provided by each company and may have additional multiple functions such as sharing photos. Embodiments of app 114 may permit participants in the tour industry such as suppliers and agents to communicate with one other.

An agent's mobile device establishes a communication session with a supplier's mobile device via the chat client feature or messaging client module of app 114 installed on each device, which utilizes the messaging service of application server 106. An agent can thus communicate directly with a supplier to ask questions and share photos but also even book a tour with the supplier within the chat environment. While an agent is chatting with a supplier, that agent may optionally see a button on app 114 for booking tours, which may be labelled “BOOK TOUR” or “PURCHASE ITEM” or the like. Clicking on a “BOOK TOUR” button, displays a reservation form, which may be similar to the form shown in FIG. 8. The agent can thus book the tour immediately for his or her guests using a credit card. Within the messaging client module (or communication module or chat module) of the app 114, a user can both chat with and book services of (or purchase items from) another party or business such as a tour supplier, a hotel, a pizza restaurant, a ticket seller, a food delivery restaurant, or another vendor, while simultaneously communicating with these providers.

Finding Other Users and Companies

The app 114 also allows the user to see all other users of the app and tour supplier and agent companies within their city at the same time. That is the mobile computing device 112l receives from the messaging service of server 102, a list of mobile devices associated with users that are in data communication with the messaging service at the server as shown in FIG. 11 and FIG. 12. The device 112 may then receive a selection input selecting one of the users (or their mobile devices) in the list; and in response to receiving the selection, establish a messaging session with the selected mobile device through the communication service.

In FIG. 11, the user may scroll through a directory listing that selectively displays companies having a predetermined geographical distance from the current location. A user can also search for a specific company or user via a search bar in app 114.

Types of Users

In some embodiments, there are at least two types of users allowed in the app 114. The first set of users are business users that belong to a company in a specific industry. These business users can communicate and book services between each other in a specific industry for business-to-business (B2B) commerce. Examples of such users with in the tour industry would be members of tour suppliers and agents that communicate with one another.

The second set of users are consumers or end users that may have questions about products and may also wish to reserve or purchase tours directly. A tour supplier may allow end consumers to communicate and purchase products directly through app 114. These end consumers can search for companies in specific industries such as tour suppliers, hotels, pizza restaurants, ticket sellers, food delivery restaurants, vendors and the like, and communicate directly with these providers. If the provider company has products or services enabled for booking or purchasing via the app 114, then the end users may see a purchase button for booking or purchase directly. As described above, the app 114 supports both business-to-business (B2B) and business-to-consumer (B2C) communication and further allows purchasing.

Although detailed exemplary embodiments have been discussed in relation to booking requests made via Junglebee for tours, those of skill in the art will readily understand that the invention is not confined to just tours, but includes excursions, activities, rentals, private charters, tickets to shows and amusement parks and many other local attractions and activities.

Having thus described, by way of example only, embodiments of the present invention, it is to be understood that the invention as defined by the appended claims is not to be limited by particular details set forth in the above description of exemplary embodiments as many variations and permutations are possible without departing from the scope of the claims.

What is claimed is:

1. An automated booking system comprising:
a server comprising: a processor; memory interconnected with the processor; a network interface in communication with the processor; the memory storing processor executable instructions that, when executed, cause the processor to:
maintain data structures corresponding to a booking list and an ordered standby list, the booking list and the standby list for storing entries identifying at least one participant;
receive input requesting a new booking entry from a user for at least one new participant;
receive and process payment information comprising account detail and payment amount for an activity corresponding to the new booking entry;
upon receiving said new booking entry and processing said payment information, add the new booking entry into the booking list;
receive input identifying a booking entry in the booking list to be cancelled; and
in response to receiving the input identifying the booking entry to be cancelled:
retrieve a top entry of the ordered standby list;
upon retrieving the top entry, replace the booking entry to be cancelled in the booking list with the top entry; and
remove the top entry from the standby list.

2. The automated system of claim 1, wherein the processor executable instructions further cause the processor to perform the steps of:
for each one of a plurality of activities,
obtaining predetermined values for a minimum number of participants N_{MIN} to be booked at time T_{MIN} and the maximum capacity of said each activity N_{MAX};
receiving a booking request at time t for n participants;
upon finding that t is later than T_{MIN}, retrieving and sending for display at a client device only those available activities satisfying n+N>N_{MIN} and retrieving and sending for display at said client device all available activities otherwise, where N is the number participants already booked for said each one activity;
receiving input representing a selected activity from the retrieved activities;
upon finding that n+N<=N_{MAX}, approving the booking request for the selected activity and otherwise declining the booking request,
wherein said approving and said declining are performed in real time and upon said approving said data structures corresponding to the booking list are modified to reflect approval of said booking request.

3. The automated system of claim 2, wherein the booking request is provided by a user comprising one of: an agent and an end user customer, the processor further providing a status for the booking request to the user.

4. The automated system of claim 2, wherein said activities are tours.

5. The automated system of claim 4, wherein said tours comprise at least one of: snorkeling, powerboating, sailing, jet skiing excursions, catamaran cruises, local activities, local shows, scuba diving, and amusement parks.

6. The automated system of claim 2, wherein the processor executable instructions further cause the processor to perform the steps of:
upon finding that t is later than T_{MIN} and t earlier than the start time T_{START} for the activity corresponding to the booking request:
sending a request message to a supplier of the activity corresponding to the booking request;
receiving a response message from the supplier;
upon finding the response message indicates approval, registering that the booking request is approved on the server; and
providing a status of the booking request to at least one of the end user customer and the supplier.

7. The automated system of claim 1, wherein the data structures comprise tables in a database.

8. The automated system of claim 1, wherein each of the entries in the standby list includes an associated contact address, the processor executable instructions further causing the processor to: send a confirmation message to the contact address associated with the selected booking.

9. An application messaging system comprising:
a client device comprising: a client processor in communication with a display, a client network interface and a computer readable medium storing application code (app) causing the client processor to:
receive a list of users in communication with a messaging service;
receive input selecting one of the users in the list of users;
in response to receiving the input selecting one of the users, establish a messaging session with the selected user through the messaging service;
display a user interface control for entering a new order entry;
upon receiving input on the user interface control, receive data for the new order request; and
send the data for the new order request to the server, while in said messaging session; and
a server comprising: a server processor; memory interconnected with the server processor; a server network interface in communication with the server processor; the memory storing processor executable instructions that, when executed, cause the server processor to:
provide the messaging service;
maintain data structures corresponding to an order list for storing order entries identifying at least one participant or item;
receive input requesting a new order entry from a user for at least one new participant or item;
receive and process payment information comprising account detail and payment amount for an activity corresponding to the new order entry; and
upon receiving said new order entry and processing said payment information add the new order entry into the order list.

10. The application messaging system of claim 9, wherein the list of users is grouped by a plurality of groups, each user associated with at least one of the groups, wherein the app further causes the client processor to: display a list of the plurality of groups on the display.

11. The application messaging system of claim 10, wherein the groups are companies and the app further causes the client processor to:
receive input selecting an entry from the list of said plurality of groups; and
upon receiving the input selecting the selected entry, display a list of users corresponding to a company associated with the selected entry.

12. The application messaging system of claim 11, wherein the plurality of groups comprises one or more of tour suppliers, agents, hotels, food delivery restaurants, pizza restaurants, ticket sellers and vendors.

13. The application messaging system of claim 9, wherein said instructions the app further causes the client processor to:
receive input requesting a new order entry from a user for at least one participant or item; and
provide commands to the server for adding the new order entry into the order list at the server.

14. The application messaging system of claim 9, wherein the client device is a one of a mobile device, a tablet, a desktop computer, a laptop, a smart phone.

15. The application messaging system of claim 9, wherein the processor executable instructions at the server further cause the server processor to perform the steps of:
for each one of a plurality of activities or items,
obtaining predetermined values for a minimum number of participant or items N_{MIN} to be ordered at time T_{MIN} and a maximum quantity available N_{MAX} for said each activity or item;
receiving an order request at time t for n participant or items;
upon finding that t is later than T_{MIN}, retrieving and sending for display at a client device only those available activities or items satisfying n+N>N_{MIN} and retrieving and sending for display at a client device all available activities or items otherwise;
receiving input representing a selected activity or item from the retrieved activities or items;
upon finding that n+N<=N_{MAX} approving the order request and otherwise declining the order request,
wherein said approving and said declining are performed in real time and upon said approving said data structures corresponding to the order list are modified to reflect approval of said order request.

16. A non-transitory computer-readable medium for a widget comprising processor executable installation instructions that, when executed by a computing device comprising: a processor; memory interconnected with the processor; a network interface in communication with the processor; cause the computing device to execute the steps of:
retrieving a Uniform Resource Identifier (URI) associated with a web application;
installing the web application on the computing device; and
upon instantiating the web application, displaying the content of the URI;
wherein the web application is on a server comprising: a server processor; memory interconnected with the server processor; a server network interface in communication with the server processor; the memory storing processor executable instructions that, when executed, cause the server processor to:
maintain data structures corresponding to a booking list for storing booking entries identifying at least one participant;
receive input requesting a new booking entry from an end user for at least one new participant;
receive and process payment information comprising account detail and payment amount for an activity corresponding to the new booking entry;
upon receiving said new booking entry and processing said payment information:
add the new booking entry into the booking list; and
automatically apportion the payment amount between a first account associated with an owner of the server, and at least a second account associated with one of an agent or a supplier for said activity.

17. The non-transitory computer-readable medium of claim 16, wherein said payment amount is a percentage of a full price for the activity associated with the new booking entry.

18. The non-transitory computer-readable medium of claim 16, wherein said Uniform Resource Identifier (URI) is a uniform resource locator (URL).

19. The non-transitory computer-readable medium of claim 16, wherein said installing the web application comprises one or more of:
installing a plugin for a browser software;
updating files at the computing device via a script; or
updating header files for a website running at the computing device.

20. The non-transitory computer-readable medium of claim 16, wherein said at least second account comprises both an account for an agent of the activity and an account for a supplier of the activity.
